(19) United States
(12) Patent Application Publication
(10) Pub. No.: US 2006/0127355 A1
(43) Pub. Date: Jun. 15, 2006

(54) Selected mixture for animal lure

(76) Inventor: Keith Ainsley, Cortland, OH (US)

Correspondence Address: LEV INTELLECTUAL PROPERTY CONSULTING, 4677 MICHIGAN BOULEVARD, YOUNGSTOWN, OH, 44505, US

(21) Appl. No.: 11/340,943

(22) Filed: Jan. 27, 2006

Related U.S. Application Data
(63) Continuation-in-part of application No. 09/524,928, filed on Mar. 14, 2000, now Pat. No. 6,991,784.

(51) Int. Cl. A01N 25/00

(52) U.S. Cl. 424/84

(57) ABSTRACT

The present invention is a lure optimized for a particular animal such as deer. The optimized lure is made using urine from only two animals urinating at approximately the same time. The animals can be either male or female, but preferably, females in estrus are used for optimal results. This mixture of urine is not diluted in any manner with that of additional animals or preservatives. The urine for the lure is obtained by using a single stall exclusively for only two animals for the purpose of gathering urine. This technique has been especially effective in attracting wandering bucks in rut.

### PRIOR APPLICATIONS

This is a continuation-in-part of allowed U.S. patent application Ser. No. 09/524,928, filed Mar. 24, 2000.

### FIELD OF THE INVENTION

The present invention relates generally to the field of animal lures used for attracting selected animals. In particular, the present invention is directed to a lure having a particular mixture of animal urine devised for optimal attraction for selected animals, and a method of producing the lure.

### BACKGROUND OF THE INVENTION

Hunting wild animals, especially herd animals such as deer or either deer-like animals (Cervidae or other Ruminants), is an art. It requires the proper mix of intelligence, patience, endurance and the proper equipment. However, even all of these factors are not necessarily sufficient for a successful hunt. In many cases some of these factors are missing so that special assistance is necessary. One such form of assistance is provided by scent masking agents, or animal lures.

Because animals like deer rely heavily on their highly developed sense of smell to alert them to a variety of dangers, it is necessary for hunters to hide their scents, thereby avoiding alerting the deer to the presence of the hunters. Techniques for doing this have been used for thousands of years. Yet, this alone is seldom sufficient to guarantee success, especially to unpracticed or unskilled hunters.

While it is necessary to cover the scent indicating the presence of the hunters, it is also very helpful to provide some means to attract the animals to the hunters' vicinity. This is accomplished through the use of scent lures, some of which have been used for thousands of years, in some form or other, by hunters to attract their prey.

In the past century, the manufacture and sale of lures, including scented lures has become a major commercial enterprise. With respect to deer (the most widely hunted game animal in the United States) and deer-like animals (Cervidae and other Ruminants), a lure is often used to attract a wandering buck to a hunter's vicinity so that the buck can be easily taken. Bucks, especially dominant or mature individuals are the objects of the vast majority of hunts.

The use of such lures is not limited to hunters but also can be used by photographers or conservationists wanting to study, tag, or move selected animals.

The ideal time for hunting bucks (or males of other deer-like Ruminants), especially mature or dominant bucks, is during the time that does go into heat or estrus, so as to be sexually receptive to the bucks. Such does are temporarily receptive to any mature (sexually active) male deer. The mating season also induces an intense state of sexual excitement in males, commonly referred to as a “rut”. During this time, bucks tend to become very predictable in their aggressive activities.

During this state of rut, a buck will mark off his territory for breeding purposes as part of a search for receptive females, or as means for protecting an existing herd including females in estrus. Usually this is done by urination and other forms of marking. The buck will then attempt to prevent other bucks from entering his breeding territory (dominating that territory), and will herd any available does in estrus within the breeding territory so as to mate with as many of them as possible.

A standard method for a buck to mark its breeding territory is the use of a “mating scrape”, which is usually an approximately circular area on the ground about two or three feet in diameter. This area is cleared of all leaves and debris by the buck pawing and scraping the area with its hooves. After the scrape has been made, the buck urinates down the tarsal gland on its leg over the scrape. The tarsal gland is a gland on the hock of a deer leg, and is used to communicate the buck's presence to other deer. The tarsal gland contains both sebaceous and sudorific glands connected to hair follicles that act as ducts to bring pheromone secretions to the surface of the bucks hide. These secretions form a musky dust on the hair follicles in the area of the buck's tarsal gland.

The urine picks up the dust from the hair follicles as it flows, and delivers the mixture to the femoral gland, located between the tarsal gland and the hoof. From there, the urine flows over the inter digital gland located on the hoof of the buck. The mixture of the urine and secretions from the three glands is then deposited on the ground which produces an odor indicative of the particular buck's presence.

As a result, the “mating scrape” is both a visual and olfactory signal for both bucks and does. Usually, a receptive doe entering the mating area so marked, will urinate on the scrape to signal her presence and her state of estrus. In the case of other bucks which come into the area, the “mating scrape” will be an immediate indication that another buck has already marked off that area as his breeding ground. This will very often stimulate more aggressive behavior on the part of bucks in rut. Thus, the scrape will act as either a warning or a challenge to other bucks, as well as an invitation to does.

One strategy for hunters, or others seeking to capture or get close to a buck in rut, is the creation of a “mock scrape”. This is done by imitating the buck's markings on the ground and applying an appropriate lure containing the scent of a buck in rut. However, this is not necessarily the optimum method of attracting a wandering rutting buck since a buck in rut is most interested in the scent of females in estrus, and there was always a chance that the buck may avoid the territory of another buck in rut, especially if there is some indication that the marked territory belongs to a larger and stronger animal. Consequently, many hunters and others hoping to come close to a buck in rut will use urine from a doe, preferably one already in estrus or heat.

Conventional methods of making buck lures usually includes a mixture of fermented tarsal glands of several animals. The fermenting generally takes place in urine, also obtained from several animals. The urine is usually a combination of buck, doe and fawn urine. As a result, a buck detecting such a scent will be led to believe that a large herd of animals is nearby. Since whole herds of does and fawns are normally controlled by a large dominant male, it is almost certain that such a scent conveys the presence of at least one powerful male, perhaps more. The herds are always aggressively defended by at least one dominant male, and by other lesser males. Such a herd may be indicated by the scent as including other bucks in rut. As a result, a wandering buck in rut may actually avoid the lure to avoid a hard fight, despite the attraction of detecting does in estrus.

Since lures based upon deer urine have a refrigerator life of approximately three months, it is necessary to add preservatives in order to increase the shelf life of this product. As a result, the urine product is no longer natural, and may not operate nearly as effectively as a natural urine product. Also, there is another limitation in obtaining a urine lure since the preferred urine is from a doe in estrus, and the mating season is limited. As a result, the production of scented lures using the optimum doe urine ingredient (from a doe in estrus) is severely limited.

Because the collection of doe estrus urine is so difficult, and the product awkward to store, it is common in the conventional art to mix a variety of different does urines from many animals, as well as gland products, into a single batch of buck lure. The resulting product is less than optimal for luring a wandering buck in rut to a particular location. Accordingly, there is a substantial need for a buck lure formula constituted by a formula optimized to lure a single buck to a particular area. There is also a definite need for a system that easily produces such a lure.

### SUMMARY OF THE INVENTION

Accordingly, it is one object of the present invention to overcome the drawbacks of the conventional art.

It is another object of the present invention to provide a formula for a buck lure that is optimized to draw a buck in rut to a particular area.

It is a further object of the present invention to provide a method by which an optimized buck lure can be produced.

It is an additional object of the present invention to provide a simplified system for producing a buck lure.

It is still another object of the present invention to provide an effective lure for a variety of different animals.

It is again a further object of the present invention to provide a system that optimizes the effectiveness of urine collected for lure purposes.

It is yet an additional object of the present invention to provide a buck lure capable of attracting animals despite the nearby presents of natural scrapes.

It is again another object of the present invention to provide an animal lure that is relatively free of bacteria and as a result has a long shelf life.

These and other goals and objects of the present invention are achieved by a buck lure for a designated Ruminant species including the urine of only two animals of that designated species.

### DETAILED DESCRIPTION OF THE PREFERRED EMBODIMENTS

The present invention is directed to a buck lure for a variety of different animals in the suborder Ruminanta. The best example are those members of the Cervidae family, which include, deer, elk, and caribou, among others. With such a wide variety of animals subject to the present invention, as a matter of necessity, only a limited number of species are used by way of example. The best example of an embodiment of the present invention is white-tailed deer. This species was selected because of its numbers and popularity as game in the United States. Consequently, it was also the first species tested, as indicated in Example 1. Thus, the embodiment directed to white-tailed deer is discussed as an example throughout this application.

It has been determined through experiments and observation of both free and penned deer that certain habits and characteristics predominate during the deer mating season. The lures of the present invention and the method for producing the subject lures are configured in response to these observations. Drawings are not needed to support the present invention since the written description of the constitution of the present invention and the techniques for making it are considered sufficient for one skilled in this technology to practice the present invetion.

The examples provide details of the observations, and the basis for the conclusions described ‘infra’. The examples describe test results based upon the observations made of both whitetail deer (Examples 1 and 2) and elk (Examples 3 and 4), and other animals (Examples 5-12). The outstanding difference between the performance of the claimed invention and other formulations is a clear indication of unobvious ness. The comparison was made between the claimed formulation of the present invention and formulations having the urine of only a single doe, and another formulation having the urine of more than two does. The outstanding performance of the claimed invention in comparison of these other two, apparently similar, formulations was unexpected. This has led to many of the following discussion of deer behavior, as well as the behavior of other deer-like ruminants.

For the sake of hunting efficiently, the nature of the animals being hunted must be carefully considered. The nature of the prey animal will determine the behavior of the animal, and allow an intelligent hunter to anticipate its movements. Unfortunately, in many cases, such knowledge is not sufficient to permit even the best of hunters to conduct efficient hunts.

Very often, constraints upon the hunters do not permit successful hunts unless extravagant amounts of time and/or resources have been made on an effort that brings in very little in terms of a reward to justify the expenditure of resources. Most especially, substantial amounts of time must be used by successful hunters. While this was once an absolute necessity for those who subsisted on prey, in a modern society, it is often viewed as unproductive or even wasteful.

One traditional and modem answer is the use of animal lures. Water, salt and sources of food have always been used by hunters to attract certain types of game. This has always worked best with game that is relatively bold in its attempt to quickly obtain food. Usually, such game are predators themselves, and very often not suitable for human consumption. Further, substantial hunting of predators has often led to adverse ecological outcomes. As a result, current hunting of predators (especially in the continental United States) is very limited. Often, it is done as a matter of “pest control”, and generally includes humane relocation of the much diminished predator species.

At present, the most popular game animals are those that can be used as food, as well as trophies. In the more recent times, further considerations have also developed. For example, with the near extinction of all natural predators in the continental United States, the deer population has grown so large that it must be harvested to prevent wide spread starvation and adverse impact to the ecologies of many areas.

However, hunting deer and similar animals is not like hunting relatively bold predators. Deer and other members of the suborder Ruminantia survive through the use of heightened senses and extreme wariness. These factors are heightened by a “herd mentality” that allows dangers sensed by one individual to impact the awareness of the rest of the herd, thereby making all members of the herd much safer.

All of this makes the hunting of Ruminants or deer like animals much more difficult for humans. This is especially true if those humans are not particularly skilled outdoorsmen, but spend only a limited time each year practicing the ancient arts of stalking prey. For such individuals, the use of animal lures obtains increasing importance.

Since deer and other Ruminants are browsers, they generally cannot be lured by food sources unless they are facing starvation. This is seldom the case during the hunting season in the continental United States, specifically during deer and elk hunting seasons.

Deer and elk, the most popular prey animals for American hunters, are classified in the family Cervidae. This family is classified under the suborder Ruminantia (Ruminants, which includes families of antelope, giraffe, musk deer, mouse deer, and pronghorns. Many families in the suborder Ruminantia, especially all Cervidae exhibit very similar behavior, in particular, “herd behavior”. This also means that the Ruminants tend to follow similar mating behavior.

With deer-like animals and other Ruminants, mating behavior provides a crucial attribute for designing lures. Female Cervidae and other Ruminants tend to remain wary at all times. This behavior is not true of males (especially dominant bulls) in rut. They exhibit substantially more aggressive behavior during this time, making them much better targets of opportunity for human hunters, who are able to take advantage of known behavior patterns.

Recognition of certain characteristics of deer and deer-like animals among the Ruminants has occurred over a long period of time, especially with respect to mating behavior. Theories have been developed and confirmed by relatively recent tests, such as those fully described in the following examples.

Based upon detailed tests described in the examples both elk and white tailed deer have shown a marked preference for a particular formulation of lure based during rut. Because of the similarity in behavior among many Ruminants, especially during mating season, the same type of formulation should be equally efficacious on other Ruminants.

It has been discovered that a buck in rut is most attracted to the scent of two does in estrus rather than a single doe in estrus or a herd containing a number of does in estrus. To a rutting buck, two does in estrus are always preferable to a single doe.

On the other hand, a herd of deer containing at least one dominant buck is not nearly so attractive to a wandering buck in rut since he may have to fight to breed. Even if the presence of other males is not a deterrent (as it so often is), a large number of does (even those in estrus) tend to scatter upon the appearance of a new buck, and tend not to quickly reunite. As a result the buck is often left with only one doe in estrus.

In contrast to this behavior of a large herd, a group limited to a single pair of does will quickly rejoin, even if initially startled into a flight which splits the two. As a result, if the wandering buck in rut is able to corner and acquire one doe, he will soon have the other. This understanding is instinctive to all male deer (as well as many other herd animals) as the optimum scenario for a wandering buck in rut.

Accordingly, based upon test observations, the optimum buck lure will consist of the urine of only two does in estrus. To add the urine of more such does, would simply serve to “confuse” the wandering buck, and lead him to become more wary of what smells to be a less than optimal situation. Cutting the urine of two does in estrus with the urine of fawns, bucks and does not in estrus, would also serve to increase the wandering buck's caution, and serve as a less effective lure. Any form of “cutting” the urine from the two does in estrus would simply lessen the strength and thus, effectiveness of buck lures made from the mixture. Likewise, the use of preservatives only serves to deplete the concentration of the two doe urine mixtures and thus, lessen its effectiveness as a buck lure. Accordingly, the use of pure urine from two different does in estrus has been found to be the optimal lure for a wandering buck in rut.

Obtaining the optimal urine mixture of two does in estrus is problematical using conventional urine-gathering techniques. Normally, urine is gathered in special stalls used by a large number of different animals. Usually, such stalls include a system of troughs or under floor conduits for gathering the urine. Typically, many animals are kept in such stalls so that there is a mixture of urine from many different animals, even if only a limited number of animals are using the stall at any one time. In many cases this situation is further complicated by the use of such stalls to feed the animals as well as gather urine. The result of conventional techniques must be that only a urine mixture from more than two animals can easily be collected for use in lures.

The optimal buck lure of the present invention is produced by carefully limiting the use of a single stall to only two does. No other animals are allowed into a selected stall that has been designated for two specific does in estrus. Feeding of the does is preferably not carried out in the selected urine-gathering stall. However, feeding can be done to lure the animal into the stall, as well as taking the animal out once the urination cycle is complete.

The urine gathering stall is used only for two does in estrus during the estrus cycle for each of the two. Afterwards, the stall can be scrubbed down, and if need be, disinfected before being used by two new does in estrus. It should be noted that conventional means, including floor/screens, filters and the like, are used to separate the feces from the urine. The urine from each deer is gathered using conventional trough arrangements while the feces is disposed of in the conventional manner.

Through long experimentation with the buck lures made from the urine of two does in estrus, it has been determined that the optimal effectiveness of the two urine mixture occurs when a first doe in estrus is allowed to urinate in the designated stall, and a second doe in estrus is led in as the first doe is lead out. The two does can also be left together for a short period of time to establish physical contact. It has been found that such physical contact tends to enhance hormone production of the second doe more certainly than mere visual contact between the two does. However, in many cases the same good results are achieved simply by the visual contact between the two does. Apparently the limited visual and physical contact between the first and second does coupled with the extremely strong smell of the freshly produced urine of the first doe leads to a maximum glandular production on the part of the second doe. The reasons for this phenomenon are not clear. It is only known that the limited visual and physical contact coupled with the maximum olfactory contact apparently enhances the glandular production of the second doe in estrus.

It should be noted that while the optimal lure for the wandering white-tailed buck in rut has been described above, the technique of the present invention is not limited thereto. For example, the technique of using only two animals per stall can be used with other species. In particular, any herd animal, similar to white tailed deer, such as elk, moose, mule deer, caribou, or the like, can be used for making effective two-animal urine lures for that species. The examples indicate the clear effectiveness of (in comparison with other similar products) of the present invention for both white tail deer, and elk. Other similar animals in view of similar nature of such animals, including the entire Cervidae Family, the comparative effectiveness of the formulation of the present invention should apply to all 46 species within this family, as well as many other ruminants. As shown in the remaining examples, the formulation made using the methodology of example 1 shows the same effectiveness to other species in the family with the claims two animal formulation having unexpected and significantly enhanced effectiveness.

In another variation of the present invention, it has been discovered that an effective (although less than optimal) white tailed buck lure can be produced from the urine of two does which are not in estrus. This is done using the same techniques as previously described with deer in estrus. While the resulting mixture is less effective as a buck lure than that made from urine of deer in estrus, a reasonably effective buck lure can still be produced, and is more effective than. The chief advantage of using urine from deer that are not in estrus is that the buck lure can be produced at any time of the year rather than only during the short estrus cycle of the white tailed deer.

There are other circumstances in which the technique of the present invention can be used in yet another embodiment. Besides using the urine of does in estrus to attract rutting bucks, there is another type of lure that can be used. For situations in which a dominate buck in rut has already established a territory and dominion over a herd of does, the intrusion of other rutting bucks within the first buck's mating territory will provoke an immediate investigation. Upon finding a wandering buck in its mating area, the dominant buck will seek immediate contact to repel the intruder. The use of a lure containing the urine of only two bucks in rut, gathered in accordance with the previous embodiments of the present invention, serves as a particularly effective attractant to a dominant buck already surrounded by does in his own mating area. In contrast, for such a situation, the domination of two new does will probably not be nearly as compelling as the protection of the herd by routing a competitor. The detection of a intruder into the dominant buck's mating area is greatly facilitated through the use of urine from only two bucks in rut. It has been discovered that the use of urine with more than two bucks is confusing to the dominant buck, and can often be interpreted by that buck as meaningless rather than a situation demanding immediate attention.

As with does in estrus, the technique of leading a second buck into the urine-gathering stall while the first buck is being removed tends to enhance production of hormones and resulting scents in the second buck as it urinates. As with the single stall used for two does in estrus, a single stall is used for only two bucks in rut, and is thoroughly cleaned afterwards before being used by other animals.

The performance and longevity of such animal lures can be improved by killing bacteria. However, it is important that the nature of the two animal urine lure not be altered by any purification process. Experimentation has demonstrated that this is done through the use of ultraviolet treatment of the urine. The removal of the bacteria destroys contaminates that could compromise the lure. It could also result in a much longer “shelf life”.

### Examples

The effectiveness of the present invention is best understood by reference to the following examples.

### Example 1

### White-tailed does in estrus

Two experienced investigators, experts in the behavior of deer and other Cervidae ran two independent series of tests. Both series of tests used the same procedure, and were conducted in the same manner in four different environments over a predetermined amount of time (as specified in Appendix I).

For each environment the test procedure included monitoring each of four test plots (mock deer scrapes) for a predetermined amount of time each day at different times of the day. All tests were conducted from a remote location so that the presence of the observers would not interfere with the behavior of the animals observed. All practical expedients were maintained to avoid contaminating the various test sites with extraneous factors.

Full protocol and execution for the tests are included in Appendix I attached hereto. In summary, a comparison was made between four different formulations, at different test scrapes at each test site or environment. The first scrape was baited with diluted tap water. The second scrape was baited with various types of single doe urine scents, taken only from does in estrus, harvested in a manner to assure quality of content. The thirds scrape was baited with the two animal formulation of the present invention, taken only from two does in estrus. The forth scrape included various formulation of urine from 3 or more does in estrus.

Results of the observations concluded that 92% of the observed deer showed a marked preference for the scrape that contained the two animal formulation as claimed for the present invention. Of the other 6%, 4% ran off after live does that they had spotted in the area. Two percent of the bucks started fighting or chased off other bucks. The remaining 2% of the bucks started towards the scrape baited with the two animal formulation and then walked off to start feeding. They did not show any preference for the other scrapes in comparison to the scrape containing the two animal formula of the present invention.

### Example 2

### White-tailed does not in estrus

The procedure of Example 1 is followed by using the urine of two does not in estrus. The two doe formulation is tested against comparison formulations of single doe urine and a mixed blend form many does. The two doe formulation would be significantly more effective as a lure.

### Example 3

### Elk

Two experienced investigators, experts in the behavior of elk and other Cervidea carried out in two independent series of tests. Both series of tests use the same procedure, and were conducted in the same manner for the selected observation in four different environments over a predetermined amount of time.

For each environment, the test procedure included monitoring each of four test plots (mock elk scrapes) for a predetermined amount of time each day at different times of the day. All tests were conducted from a remote location so that the presence of the observers would not interfere with the behavior of the animals observed. All practical expedients were maintained to avoid contaminating the various test sites with extraneous factors.

All protocol and execution for one series of the tests are included in Appendix II, attached hereto. In summary, a comparison was made between four different formulations, used at different test scrapes at the test site. The first scrape was baited with diluted tap water. The second scrape was baited with cow elk urine from a single cow. The third scrape was baited with the two animal formulation of the present invention. The fourth scrape was baited with bull elk urine.

Results of the observations concluded that 86% usage was attributed to the mock scrape that was baited with this two animal formulation as claimed for the present invention. It is noted that the fourth test plot or mock scrape had a 60% usage by bull elk. The second plot, baited with urine from a single cow at a 40% usage by bull elk. However, elk visiting the test plot baited with the two animal formulation of the present invention showed the most aggressive behavior. This activity included wallowing staining and raking trees. Also, the cows also seemed to linger more often at the plot baited with the two animal formulations of the present invention.

Breeding activity was displayed 6 times at the plot baited with the two animal formulation. Such activity was observed only once at the plot baited with the single cow urine and zero times at the two other tests plots. It is believed that the high usage of the fourth scrape baited with bull elk urine is due to dominance issues since elk are highly combative. Very often, this was done by a bull elk after he had installed his harem near the scrape containing the two animal formulations of the present invention. Such a visitation would have been a dominance issue since the bull elk would urinate over the scrape containing the urine of another bull elk. This is interpreted as a dominance issue, secondary to the primary issue of breeding. Clearly, the use of the two cow formulation of the present invention maximizes attraction of bulls based upon a bulls reproductive instincts during breeding (hunting) season. The present invention provides the optimal formulation for bringing the most desirable prey animals to a predetermined site.

### Example 4

### Moose

The procedure of example 1 is followed using the urine of two moose cows. The two animal formulation is tested against comparison formulations of single moose cow urine and a mixed blend of urine of many moose cows. The two animal formulation would be significantly more effective as a lure.

### Example 6

### Caribou

The procedure of example 1 is followed using the urine of two caribou cows. The two animal formulation is tested against comparison formulations of a single caribou cow urine and a mixed blend of many caribou cows. The two animal formulation would be significantly more effective as a lure.

### Example 7

### Mule Deer

The procedure of example 1 is followed using the urine of two does. The two animal formulation is tested against comparison formulations of single doe urine and a mixed blend of the urine of many does. The two doe formulation would be significantly more effective as a lure.

### Example 7

### Antelope

The procedure of example 1 is followed using the urine of two antelope not in estrus. The two animal formulation is tested against comparison formulations of single doe urine and a mixed blend of the urine of many does. The two animal formulation would be significantly more effective as a lure.

### Example 8

### Red Deer

The procedure of example 1 is followed using the urine of two does. The two animal formulation is tested against comparison formulations of single doe urine and a mixed formulation of many does. The two animal formulation would be significantly more effective as a lure.

### Example 9

### Black-tailed Deer

The procedure of example 1 is followed using the urine of two black-tailed does. The two animal formulation is tested against comparison formulations of single black-tailed doe urine and a mixed formulation of many black-tailed does. The two animal formulation would be significantly more effective as a lure.

### Example 10

### Big Horn Sheep

The procedure of example 1 is followed by using the urine of two big horned sheep. The two animal formulation is tested against comparison formulations of a single big horned sheep urine and a mixed urine blend of many big horned sheep. The two animal formulation would be significantly more effective as a lure.

### Example 1

### Pronghorns

The procedure of example 1 if followed by using the urine of two pronghorns. The two animal formulation is tested against comparison formulations of a single pronghorned urine and a mixed blend urine of many pronghorns. The two animal formulation would be significantly more effective as a lure.

While a number of embodiments of the present invention have been described by way of example, the present invention is not limited thereby. Rather, the present invention should be construed to include any and all permutations, variations, modifications, adaptations and embodiments that would occur to one skilled in this art, once having been taught the present invention by the instant application. Accordingly, the present invention should be construed as being limited only by the following claims.

I claim:

1. An animal lure for a designated species of the suborder Ruminata comprising:
a) the urine of only two animals of said designated species.

2. The lure of claim 1, wherein said lure is configured to attract males of said designated species.

3. The lure of claim 2, wherein said animals are females.

4. The lure of claim 3, wherein said females are in estrus.

5. The lure of claim 2, wherein said animals are bucks in rut.

6. The lure of claim 2, wherein said animals are of the family Cervidae.

7. The lure of claim 1, wherein said urine is taken exclusively from a single stall used only by said two animals.

8. The lure of claim 6, wherein said two animals are white-tailed deer.

9. The lure of claim 6, wherein said two animals are elk.

10. The lure of claim 6, wherein said two animals are moose.

11. The lure of claim 6, wherein said two animals are caribou.

12. The lure of claim 6, wherein said two animals are mule deer.

13. The lure of claim 6, wherein said two animals are antelope.

14. The lure of claim 6, wherein said two animals are red deer.

15. The lure of claim 6, wherein said two animals are black-tailed deer.

16. The lure of claim 2, wherein said two animals are big horn sheep.

17. The lure of claim 2, wherein said two animals are pronghorns.

18. An animal lure for a designated species of a suborder Ruminata for attracting male animals of said designated species, said animal lure comprising:
the urine of a first animal of said designated species collected using collection stall; and,
the urine of a second animal said designated species collected using the same collecting stall,
wherein said second animal is in visual or physical contact with said first animal after urination by the first animal and prior to urination said second animal.

19. The animal lure of claim 18, wherein first and second animals are selected from a group consisting of two does in estrus, two does not in estrus, and two bucks in rut.

20. The animal lure of claim 19, wherein said first and second animals are of a designated species selected from a group consisting of white-tailed deer, elk, moose, caribou, mule deer, antelope, red deer, black-tailed deer, Big horn sheep, and pronghorns.
